(19) United States
(12) Patent Application Publication
(10) Pub. No.: US 2021/0276279 A1
(43) Pub. Date: Sep. 9, 2021

(54) PEELABLE SHIM HAVING INCREASED STRENGTH

(71) Applicant: SOCIÉTÉ LAMECO, Trappes (FR)

(72) Inventor: Daniel André GASTEL, Plaisir Les Gatines (FR)

(21) Appl. No.: 17/259,272

(22) PCT Filed: Jul. 10, 2019
(86) PCT No.: PCT/EP2019/068634

§ 371 Date: Jan. 11, 2021

(30) Foreign Application Priority Data
Jul. 11, 2018 (FR) 1856368

(51) Int. Cl. B29C 70/10; B29B 15/10; B29C 70/22; B29C 70/42; B32B 5/02; B32B 5/08; B32B 5/26; B32B 7/06

(52) U.S. Cl. CPC B29C 70/10; B32B 2605/18; B29C 70/228; B29C 70/42; B32B 5/024; B32B 5/028; B32B 5/08; B32B 5/26; B32B 7/06; B32B 2250/20; B32B 2255/26; B32B 2255/10; B32B 2260/023; B32B 2260/046; B32B 2262/0269; B32B 2262/101; B32B 2262/105; B32B 2262/106; B32B 2262/14; B32B 2307/306; B32B 2307/5825; B32B 2307/714; B32B 2307/748; B29B 15/10

(57) ABSTRACT

A method for producing a peelable sheet, includes the steps of adhesively bonding woven fibres with a preparation of base components for a thermosetting resin so as to form adhesively bonded sheets; stacking the adhesively bonded sheets in a stack; and converting the base components into thermoset resin. The stack of sheets is kept under pressure and, prior to being adhesively bonded, the woven fibres are coated with a deposit of a fluoropolymer.

### TECHNICAL FIELD

The present disclosure relates to peelable shims that are resistant to the demanding conditions of temperature and mechanical stress, thus, and this is remarkable, adapted to an aggressive chemical environment or to a humid environment.

### BACKGROUND

As a reminder, peelable shims are laminated products that have a thickness adjustable by shearing, of a particular production mode. The disclosure therefore also relates to the method of producing such products.

To better define what is meant by the term “peelable shim”, it is specified that it concerns a product comprising a tight stack of solid sheets connected to each other by their surfaces applied by means of an adhesive material in a sufficiently small quantity so that it is practically invisible. Each solid sheet has intrinsic tear resistance, and the adhesive material connects two adjacent sheets together with a bond strength less than the tear resistance of the sheets, so that each sheet can be detached from the stack without tearing.

These objects are widely used as thickness shims in complex mechanical assemblies, particularly in aeronautics.

The mechanical assemblies in which peelable shims find their application in particular may contain many parts, each having dimensional tolerances. The sum of the tolerances creates play that can be significant, for which it is necessary to compensate in order to allow the mechanical assemblies to perform their functions correctly.

For this purpose, adjustment shims or thickness shims are used, which advantageously are peelable. These may be shims of metal foil, shims of thermoplastic organic polymer sheets, or shims of woven fiber sheets.

In any case, these peelable shims are composed of thin lamellas (sheets) superimposed and adhesively bonded together so as to define a chosen thickness perpendicular to the plane of the sheets, and whose lateral contours, in the plane of the sheets, are machined to adapt to the geometry of the spaces to be shimmed.

The shim is adjusted by reducing its thickness by peeling off one or more of these strips and inserting the shim at the point where the play is found.

Fiberglass, carbon, ceramic or aramid fabrics are used with the aim of reducing the weight of the parts and achieving high mechanical strength and heat resistance.

Shims of fibrous materials are also used preferably with parts made of composite materials, to avoid abrasive wear between materials of different natures.

### SUMMARY

In this context, one object of the disclosure is to propose a laminated product that overcomes the difficulties described above, and that offers increased resistance in aggressive chemical environments, or in humid environments.

For this, a method for producing a peelable sheet is proposed, comprising adhesively bonding woven fibers with a preparation of base components for a thermosetting resin so as to form adhesively bonded sheets, stacking said adhesively bonded sheets in a stack, and converting the base components into thermoset resin, the stack of sheets being kept under pressure and, prior to being adhesively bonded, the woven fibers being coated with a deposit of fluoropolymer.

This method leads to shims that provide the expected qualities: resistance to mechanical stress, especially shocks, resistance in aggressive chemical environments or humid environments, and resistance to high temperatures.

According to advantageous features,
the fluoropolymer is polytetrafluoroethylene and before adhesively bonding the fiber sheets coated with this deposit are stripped, for example with a Tetra-Etch solution;
the woven fibers form a satin-like mesh;
the sheets are coated with the said deposit by micro-spraying before being adhesively bonded;
the resin is a cyanate ester resin;
conversion to a thermoset resin comprises heating to 180° C.;
the fibers are glass, carbon, ceramic or aramid fibers.

A peelable sheet is also proposed, comprising a stack of sheets of woven fibers coated with a fluorinated polymer, held together by a thermoset resin.

And the disclosure relates to the use as a thickness shim of a peelable sheet as described above, or obtained by a production method as described above.

### BRIEF DESCRIPTION OF THE DRAWINGS

Other features and advantages of the disclosure will emerge clearly from the description given below, which is indicative and in no way limiting, with reference to the appended drawings, in which:

FIG. 1 is a perspective view of the fabric used in the disclosure before impregnation;

FIG. 2 is a perspective view of a fabric from FIG. 1 impregnated for the purpose of the disclosure; and

FIG. 3 is a perspective view of the product being assembled.

### DETAILED DESCRIPTION OF THE DRAWINGS

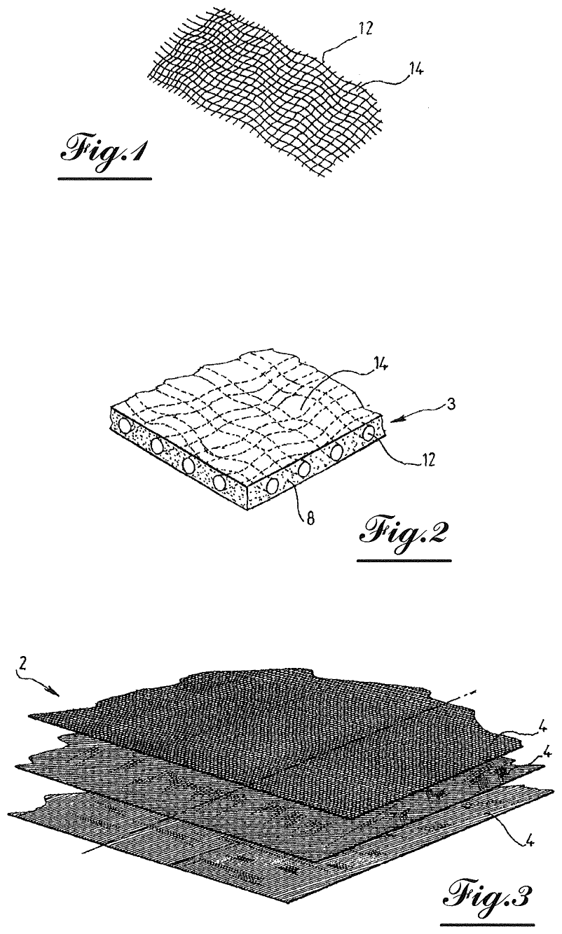

The disclosure relates to a laminated product comprising a stack of sheets of woven fibers such as sheet 14 shown in FIG. 1 comprising a satin type weave of fibers 12 that may in particular be glass fibers.

These fibers 12 are interwoven, and may be fibers of glass, carbon, ceramic or aramid, or of any other material having comparable mechanical properties. Several types of fibers can be mixed in the same fabric.

Pieces of the above-mentioned fibrous fabric 12 are first cut and bonded to the desired dimensions. Each of them will form a sheet of the rolled product after processing.

These sheets are subject to impregnation by spraying or micro-spraying of a fluorinated polymer, in the mode of production presented, PTFE or polytetrafluoroethylene. A minimum amount of PTFE is applied so that the sheets are coated without being unnecessarily weighed down or thickened, as shown in FIG. 2, where a coated sheet 3 is visible, comprising sheet 14 with a PTFE impregnation 8. The fibers 12 are embedded in a fine PTFE environment 8.

Another fluoropolymer can be used, such as polyvinyl fluoride (PVF), polyvinylidene fluoride (PVDF), polychlorotrifluoroethylene (PCTFE), perfluoroalkoxy (PFA), fluorinated ethylene propylene (FEP), ethylene tetrafluoroethylene (ETFE), polyethylene chlorotrifluoroethylene (ECTFE), perfluoropolyether (PFPE), perfluorosulfonic acid (PFSA), perfluoropolyoxetane, or fluoroelastomers.

The coated sheets 3 are then treated with a stripping agent to allow them to bond to each other. The stripping agent (or corrosive agent) can be the commercially available Tetra-Etch agent (which concerns an organic solution). Other chemical or physical stripping methods can be used such as an alkaline solution (soda, potash), another organic stripping solution, or exposure to fire or plasma.

Once the stripping effect is achieved, the stripping agent is removed or withdrawn and the sheets are bonded, on one or both sides, with a thermosetting resin preparation comprising a solvent, the monomer or precursor, and optionally the chemical activating agent. In a preferred method, a cyanate ester resin is used, which allows the final product to withstand high temperatures.

The bonding operation is carried out by any type of bonding machine, spraying by means of a nozzle or a gun, by application with a manual roller, by printing on an offset type machine, or by dipping the fabric in a bath of adhesive material.

The thermosetting resin, after its process of cross-linking of monomer to polymer an adhesive material, its quantity and treatment being selected and adapted so that the bond strength between the two sheets is lower than the tear resistance of the sheets, so that each sheet can be detached from the stack without tearing.

The resin is polymerized either by heat treatment or at room temperature. In addition to a cyanate-ester resin, this can be an epoxy, phenolic, vinyl-ester or polyvinyl resin. It is preferably mono-constituent, but it can be a mixture of resins of different chemical natures.

Additives are added to the resin in some cases. These additives may include hardeners to impart specific mechanical characteristics, hardness, stiffness, or tensile and compressive strength to the rolled product.

Finally, the adhesively bonded fabric sheets 4 undergo a final polymerization process under pressure. This operation comprises arranging the sheets in stack 2, as shown in FIG. 3, between two parallel-plane supports, these supports being pressed against each other at room temperature or hot in a heating press for a predetermined time. The resin polymerizes.

This operation gives the rolled product the desired mechanical qualities of parallelism, flatness, cohesion and peelability.

The flat supports are made up of two calibrated steel plates of a high thickness, such as 50 mm. The plates are traversed at the periphery by threaded rods or screws, to which a clamp is applied.

The polymerization is carried out with temperature cycles at 120° C. and 180° C.

Finally, the rolled product is machined or cut to the correct dimensions, if necessary, so that it has the right shape and dimensions in the sheet plane.

Rolled products of this type are well suited for use as shims for the aircraft industry, for airplanes or helicopters for example, including in very hot areas such as engines, for example in an a 400° C. environment.

These laminated products can also be used as peelable shims in other fields, generally wherever light weight and mechanical and thermal resistance characteristics are required, and can be used in chemically aggressive or humid environments.

They are resistant to occasional shocks, even violent ones, created by a point hitting their surface.

1. A method for producing a peelable plate, the method including the following steps: adhesively bonding woven fibers with a preparation of base components for a thermosetting resin to form adhesively bonded sheets, stacking the adhesively bonded sheets in a stack, and converting the base components into thermoset resin, the stack of sheets being kept under pressure and, prior to being adhesively bonded, wherein the woven fibers are coated with a deposit of a fluoropolymer.

2. The method for producing a peelable plate according to claim 1, wherein the fluoropolymer is polytetrafluoroethylene and that before adhesively bonding the fiber sheets coated with said deposit are stripped.

3. The method for producing a peelable plate according to claim 1, wherein the woven fibers form a satin-type mesh.

4. The method for producing a peelable plate according to claim 1, wherein the fibers are coated with said deposit by micro-spraying, before being adhesively bonded.

5. The method for producing a peelable plate according to claim 1, wherein the resin is a cyanate ester resin.

6. The method for producing a peelable plate according to claim 1, wherein the conversion into a thermoset resin comprises heating to 180° C.

7. The method for producing a peelable plate according to claim 1, wherein the fibers are glass, carbon, ceramic, or aramid fibers.

8. A peelable plate comprising: a stack of woven fiber sheets coated with a fluoropolymer, held together by a thermoset resin.

9. Use as a shim of a peelable plate according to claim 8, or obtained by a producing method comprising adhesively bonding woven fibers with a preparation of base components for a thermosetting resin so as to form adhesively bonded sheets, stacking the adhesively bonded sheets in a stack, and converting the base components into thermoset resin, the stack of sheets being kept under pressure and, prior to being adhesively bonded, wherein the woven fibers are coated with a deposit of a fluoropolymer.
